(19) United States
(12) Patent Application Publication
(10) Pub. No.: US 2026/0237677 A1
(43) Pub. Date: Aug. 13, 2026

(54) Carbon and metal dual buffer layer to suppress lithium dendrite growth in solid-state batteries

(71) Applicant: The Regents of the University of California, Oakland, CA (US)

(72) Inventors: Haegyum Kim, Emeryville, CA (US); Venkata Sai Avvaru, Berkeley, CA (US)

(21) Appl. No.: 19/316,096

(22) Filed: Sep. 2, 2025

Related U.S. Application Data
(60) Provisional application No. 63/758,021, filed on Feb. 13, 2025.

(51) Int. Cl. H01M 4/62; H01M 4/04; H01M 4/36; H01M 4/66

(52) U.S. Cl. CPC H01M 4/628; H01M 4/0404; H01M 4/0426; H01M 4/366; H01M 4/625; H01M 4/662

(57) ABSTRACT

This disclosure provides systems, methods, and apparatus related to solid-state batteries. In one aspect, a structure includes a current collector, a layer of metal disposed on the current collector, and a layer of carbon disposed on the layer of metal.

### RELATED APPLICATIONS

This application claims priority to U.S. Provisional Patent Application No. 63/758,021, filed 13 Feb. 2025, which is hereby incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

Solid-state batteries (SSBs) have attracted significant interest from both academia and industry as next-generation high-energy rechargeable batteries. SSBs employ solid-state inorganic compounds as lithium (Li)-conducting electrolytes instead of flammable liquid organic electrolytes, improving the safety of rechargeable batteries. The higher thermal stability of solid electrolytes increases the resistance to thermal runaway compared to that of Li-ion batteries utilizing liquid electrolytes. This improved safety enables the use of a Li-metal anode, which exhibits high theoretical specific capacity (3860 mAh g⁻¹) and low potential (−3.04 V vs the standard hydrogen electrode (SHE)).

An anode-less configuration (or Li reservoir-free system) that does not contain an excess Li-metal anode but utilizes Li from a cathode to deposit on a current collector during charging of the full cell is an ideal system to maximize the specific energy (Wh kg⁻¹) of the SSBs. In addition, the anode-less concept can simplify the SSB manufacturing process by removing the Li-metal anode manufacturing and integration steps, which can reduce production cost. However, the anode-less system is prone to create inhomogeneous Li-metal plating instead of the desired uniform Li deposition, leading to a short-circuit, in particular at low stacking pressures and high current rates.

Several buffer layers (BLs) have been proposed to create uniform Li-metal plating during charging of full-cells (or discharging in Li-metal half-cells) and improve the interfacial stability between the Li-metal anode and solid electrolytes. These BLs include carbon, metal particles, carbon-metal composites, and other inorganic materials. For example, one research group developed a silver-carbon (Ag—C) composite BL and demonstrated that the thin Ag—C BL effectively regulates Li deposition, which improves the cycling stability to up to 1000 cycles with a relatively high cathode loading of 6.8 mAh cm⁻² at 60° C. One research group found that Ag nanoparticles play a key role in Ag—C composite BLs, where Ag nanoparticles drive Li-metal plating between the Ag—C BL and pre-existing Li metal, rather than at the interface between the BL and solid electrolyte. The crystallinity and microstructure of carbon BLs has also been found to determine the uniformity of Li-metal plating and the position of Li-metal deposition (at the current collector/carbon BL interface vs at the carbon BL/solid-electrolyte interface).

Recently, various metal nanoparticles and films have been investigated as BLs and current collectors to homogenize Li-metal plating. Although it is difficult to exclude external parameters such as the particle size, film thickness, and stacking pressure that could affect the electrochemical Li plating/stripping performance, in general, metals that can alloy with Li up to high Li concentrations and that have good affinity with Li metal exhibit stable Li plating/stripping cycles. For example, Zn metal exhibits inferior cycling performance compared to Au, Ag, Mg, and Sn. Recently, one research group claimed that the ability to absorb more Li makes the current at the anode more controlled by the dispersed metal nanoparticles and that uniform distribution of metal nanoparticles would help homogenize Li-metal plating.

However, the role of the carbon in the composite BL is not yet fully understood, although a few studies have demonstrated that the metal-carbon composite or dual-layered BL delivers improved cycling performance compared to metal-only or carbon-only BLs.

### SUMMARY

One innovative aspect of the subject matter described in this disclosure can be implemented in a structure for a lithium solid-state battery including a current collector, a layer of metal disposed on the current collector, and a layer of carbon disposed on the layer of metal

Another innovative aspect of the subject matter described in this disclosure can be implemented in a method including providing a current collector. A layer of metal is deposited on the current collector. A layer of carbon is deposited on the layer of metal.

Another innovative aspect of the subject matter described in this disclosure can be implemented in a method including providing a solid electrolyte. A layer of carbon is deposited on the solid electrolyte. A layer of metal is deposited on the layer of carbon.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example of a schematic representation of carbon deposited on Sn-nanoparticle layer (SUS/Sn/C). FIG. 1B shows an example of a schematic representation of carbon deposited between the Sn and SUS foil (SUS/C/Sn). FIGS. 1C-1J show SEM images and corresponding EDS mapping. SEM images of SUS/Sn/C showing (FIG. 1C) top-view and (FIG. 1D) cross-sectional view and corresponding EDS mapping of (FIG. 1E) Sn and (FIG. 1F) C layers. SEM image of SUS/C/Sn showing (FIG. 1G) top view and (FIG. 1H) cross-sectional view and corresponding EDS mapping of (FIG. 1I) Sn and (FIG. 1J) C layers.

FIGS. 2A-2D show first cycle voltage curves during discharge/charge cycle of SUS/Sn/C BL, SUS/C/Sn BL, Sn only BL, and bare SUS foil, respectively. The insets shows the first 12 min of discharge curves. FIGS. 2E-2H show galvanostatic cycling test results of (FIG. 2E) SUS/Sn/C BL, (FIG. 2F) SUS/C/Sn BL, (FIG. 2G) Sn only BL, (FIG. 2H) bare SUS foil at a current density of 1 mA cm⁻².

FIGS. 3A-3F show galvanostatic charge-discharge profiles of SUS/Sn/C BL at (FIG. 3A) 0.25 mA cm⁻², (FIG. 3B) 0.5 mA cm⁻², (FIG. 3C) 1 mA cm⁻², (FIG. 3D) 2 mA cm⁻², (FIG. 3E) 3 mA cm⁻², and (FIG. 3F) 4 mA cm⁻² with a constant areal capacity of 1 mAh cm⁻² to evaluate the critical current density.

FIGS. 4A and 4B show ex situ digital optical microscopy images at the interface of the (FIG. 4A) solid electrolyte and SUS/Sn/C, and (FIG. 4B) solid electrolyte and SUS/C/Sn BLs after Li plating. FIG. 4C shows the distance between the solid electrolyte and the buffer layers (bare SUS foil, Sn, SUS/Sn/C and SUS/C/Sn) as a function of time estimated from optical microscopy images.

FIG. 5A shows an SEM image of the discharged SUS/Sn/C BL. FIG. 5B shows an SEM image of the charged SUS/Sn/C BL.

FIGS. 6A and 6B show examples of schematic diagrams of Li metal growth behaviors with (FIG. 6A) SUS/Sn/C BL and (FIG. 6B) SUS/C/Sn BL.

FIG. 7 shows an example of a schematic illustration of a structure for a lithium solid-state battery including a current collector with a buffer layer disposed thereon.

FIG. 8 shows an example of a flow diagram illustrating a manufacturing process for a buffer layer for a current collector of a lithium solid-state battery.

FIG. 9 shows an example of a flow diagram illustrating a manufacturing process for a buffer layer for a current collector of a lithium solid-state battery.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

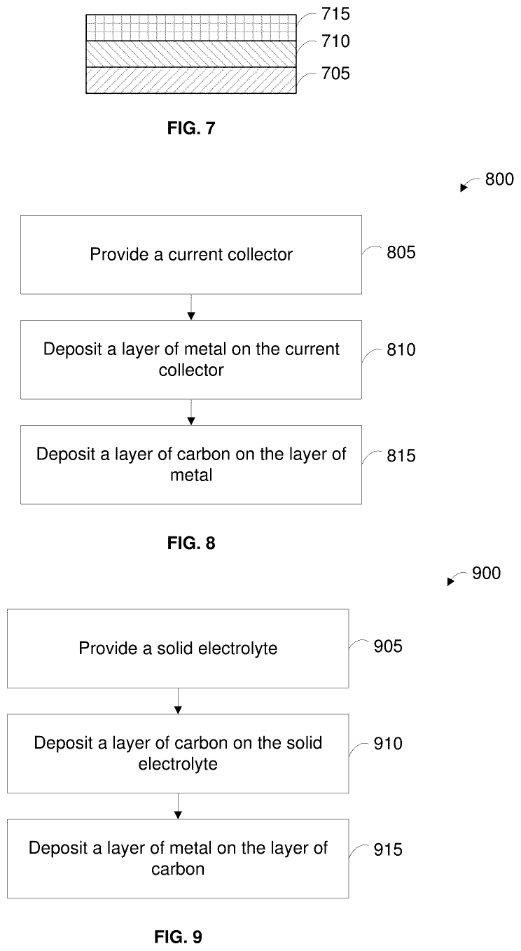

FIG. 7 shows an example of a schematic illustration of a structure for a lithium solid-state battery including a current collector with a buffer layer disposed thereon. As shown in FIG. 7, a current collector 705 for a lithium solid-state battery has a layer of metal 710 disposed thereon. A layer of carbon 715 is disposed on the layer of metal. In some embodiments, the structure further includes a solid-electrolyte layer (not shown) disposed on the layer of carbon 715. In some embodiments, a cathode material (not shown) is disposed on the solid-electrolyte layer. In some embodiments, the structure is part of an all-solid-state battery.

In some embodiments, the current collector comprises a layer of stainless steel or a layer of copper.

In some embodiments, a metal of the layer of metal is tin. In some embodiments, the layer of metal comprises tin. In some embodiments, wherein the layer of metal is about 50 nanometers to 2 microns thick, or about 100 nanometers to 1 micron thick.

In some embodiments, the layer of carbon is about 50 nanometers to 1 micron thick, or about 100 nanometers to 1 micron thick.

In some embodiments, a lithium solid-state battery including the structure described with respect to FIG. 7 comprises a current collector, a layer of metal disposed on the current collector, a layer of carbon disposed on the layer of metal, a solid-electrolyte layer disposed on the layer of carbon, and a cathode material disposed on the solid electrolyte layer.

FIG. 8 shows an example of a flow diagram illustrating a manufacturing process for a buffer layer for a current collector of a lithium solid-state battery. Starting at block 805 of the method 800 shown in FIG. 8, a current collector is provided. In some embodiments, the current collector comprises a layer of stainless steel or a layer of copper.

At block 810, a layer of metal is deposited on the current collector. In some embodiments, the layer of metal is deposited using a sputtering method. In some embodiments, a metal of the layer of metal is tin. In some embodiments, layer of metal comprises tin. In some embodiments, the layer of metal is about 50 nanometers to 2 microns thick, or about 100 nanometers to 1 micron thick.

At block 815, a layer of carbon is deposited on the layer of metal. In some embodiments, the layer of carbon is deposited using a sputtering method. In some embodiments, the layer of carbon is about 50 nanometers to 1 micron thick, or about 100 nanometers to 1 micron thick.

FIG. 9 shows an example of a flow diagram illustrating a manufacturing process for a buffer layer for a current collector of a lithium solid-state battery. Starting at block 905 of the method 900 shown in FIG. 9, a solid electrolyte is provided.

At block 910, a layer of carbon is deposited on the solid electrolyte. In some embodiments, the layer of carbon is deposited using a sputtering method. In some embodiments, the layer of carbon is about 50 nanometers to 1 micron thick, or about 100 nanometers to 1 micron thick.

At block 915, a layer of metal is deposited on the layer of carbon. In some embodiments, the layer of metal is deposited using a sputtering method. In some embodiments, a metal of the layer of metal is tin. In some embodiments, layer of metal comprises tin. In some embodiments, the layer of metal is about 50 nanometers to 2 microns thick, or about 100 nanometers to 1 micron thick. In some embodiments the process method 900 further includes positioning a current collector on the layer of metal.

In a study described below in the examples, we developed and compared two designs of dual BLs, comprising Sn and carbon, to understand the role of the carbon layer in preventing Li dendrite growth. The Sn layer was deposited on a stainless steel (SUS) current collector, and the carbon layer was deposited on the Sn layer (hereafter, SUS/Sn/C). The carbon layer was deposited on a SUS current collector, and the Sn layer was deposited on top of the carbon layer (hereafter, SUS/C/Sn). Sn only BL and SUS foil without BL were also evaluated as control groups.

To the best of our knowledge, this is the first report, investigating the role of carbon position in two different SUS/Sn/C and SUS/C/Sn BL configurations. Through electrochemical evaluations at a current density of 1 mA cm⁻² at 50° C., we confirmed that the SUS/Sn/C BL outperformed the SUS/C/Sn BL and Sn-only BL. We demonstrated that the carbon layer on top of the Sn layer extends Li plating/stripping cycles without short-circuiting. Ex situ and in situ optical microscopy analysis demonstrated that Li-metal plating occurred at the location where Sn metal exists (between the carbon layer and SUS foil current collector) in the SUS/Sn/C BL. In contrast, Li metal deposition occurs at the interface between the BL and the solid electrolyte in the SUS/C/Sn BL, which cannot avoid direct contact between Li metal and the solid electrolyte. In addition, in the SUS/Sn/C dual buffer layer, the carbon layer serves as a physical protective layer to suppress Li dendrite growth toward a solid electrolyte due to its lithiophobic properties.

The following examples are intended to be examples of the embodiments disclosed herein, and are not intended to be limiting.

### EXAMPLE

### Material Synthesis

The dual buffer layers were deposited using direct current (DC) magnetron sputtering inside an Ar-filled glovebox. The pressure was maintained at 5 Pa during the deposition in the vacuum chamber, and the power was maintained at 10 W. Metallic tin (Sn) and carbon targets with a purity of 99.99% and a diameter of 50 mm were used as sputtering targets. The sputtering was kept constant at 5 min for Sn and 20 min for carbon to achieve a uniform distribution.

### EXAMPLE

### Dual Buffer Layer Designs

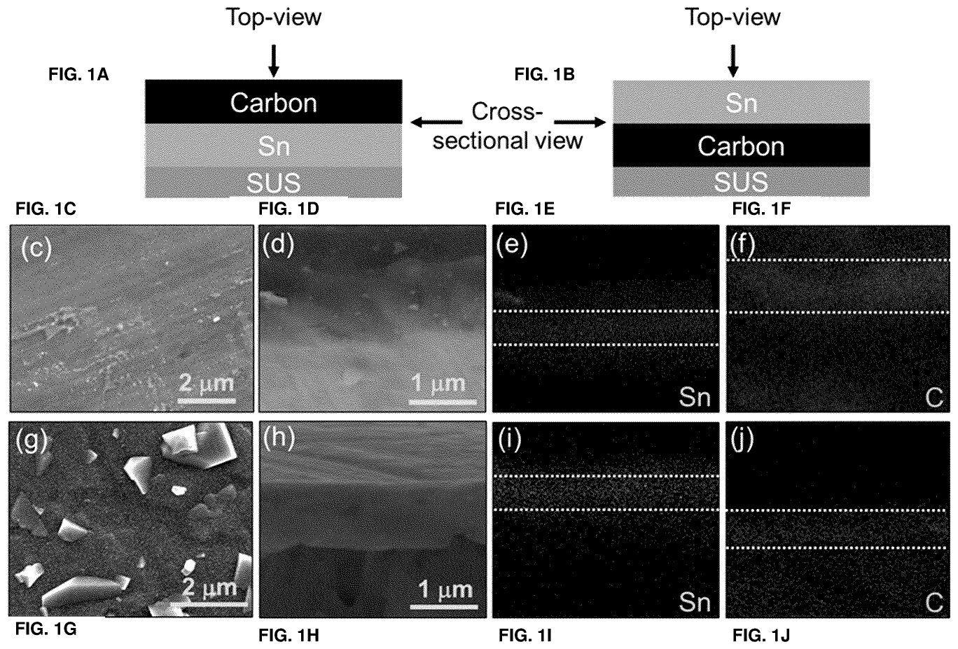

The role of carbon layers and how the position of the carbon layer affects the Li plating (discharging)/stripping (charging) for carbon-metal composite BLs performance is not known. To close this knowledge gap, we designed and evaluated two distinct BL configurations: carbon layer is deposited (i) on top of the Sn metal layer (denoted as SUS/Sn/C) and (ii) between the Sn metal layer and SUS foil (denoted as SUS/C/Sn), as shown in the schematics in FIGS. 1A and 1B. The sputtering was conducted inside an Ar-filled glovebox, thereby preventing any potential oxidation of Sn metals due to air exposure during sputtering and sample transfer. X-ray diffraction (XRD) analysis for the Sn metal-deposited SUS foils also confirmed crystalline Sn metal signals along with the SUS foil substrate. In this study, we selected Sn metals as a potential BL component for several reasons. (i) Sn is capable of absorbing a large amount of Li ions, which keeps the electrochemical potential positive and may control the current uniformly at the anode before Li-metal plating occurs. (ii) Previous studies demonstrated Li-Sn alloys as working BLs in Li-rich anode systems. (iii) Sn metals are mechanically soft, ensuring good contact with the current collector and solid electrolyte.

FIG. 1C displays a top-view scanning electron microscopy (SEM) image of the carbon deposition over the Sn metal, which demonstrates that the carbon layer is uniformly coated over the Sn metal layer because no Sn metal particles are observed in contrast to the Sn sputtered sample. The Sn sputtered SUS shows a bimodal particle size distribution of <200 nm and ~1 μm. We controlled the sputtering conditions (such as deposition power and time), but we could not create a uniform particle size distribution of Sn metals. While the sputtered Sn shows bimodal size distribution in our system, it is noteworthy to mention that all the SUS foil surface is covered by Sn particles. FIGS. 1D-1F present an SEM image of the cross-sectional view of the SUS/Sn/C BL and corresponding EDS mapping. The thickness of the SUS/Sn/C BL was estimated from the cross-sectional images, which corresponds to ~1.2 μm in total, where Sn is ~500 nm and C is ~700 nm. In contrast, the SEM image in FIG. 1G clearly shows the bimodal distribution of Sn nanoparticles on the surface of the SUS/C/Sn BL. The morphology of Sn particles remains unchanged even after depositing over the carbon layer except that the particle size slightly increased compared to Sn only sputtered sample. The thickness estimated from the SEM image and corresponding EDS mapping (FIGS. 1H-1J) of the cross-sectional view of SUS/C/Sn BL is ~1 μm. EDS elemental mapping shows a dual layer of carbon (bottom) and Sn nanoparticles (top).

To understand the role of the position of the carbon layer in the BL, asymmetric cells were assembled with an argyrodite solid electrolyte (Li₆PS₅Cl) and a Li-metal counter electrode. The asymmetric cells were cycled at a current density of 1 mA cm⁻² until the areal capacity reached 1 mAh cm⁻² or the voltage reached the cutoff of −1.0 V (vs Li/Li⁺) during plating (discharging) and 1.0 V (vs Li/Li⁺) during stripping (charging) at 50° C. In this study, we selected a slightly elevated temperature, 50° C., for cycling to mitigate potential Li dendrite growth from the counter electrode that does not have BLs.

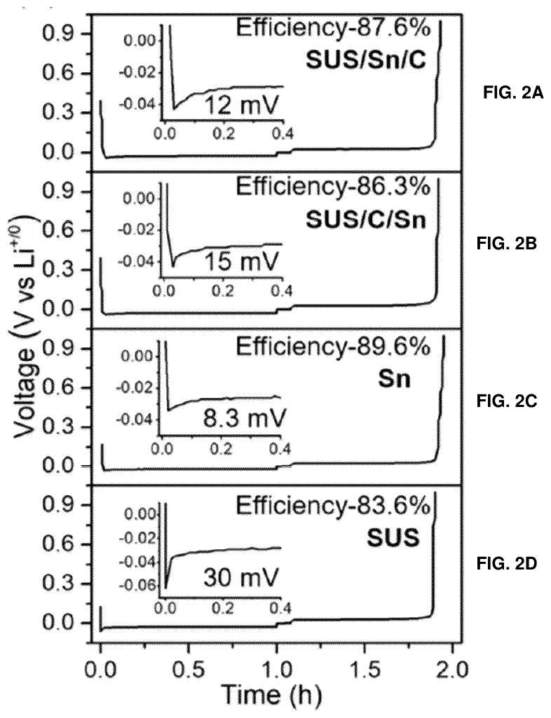

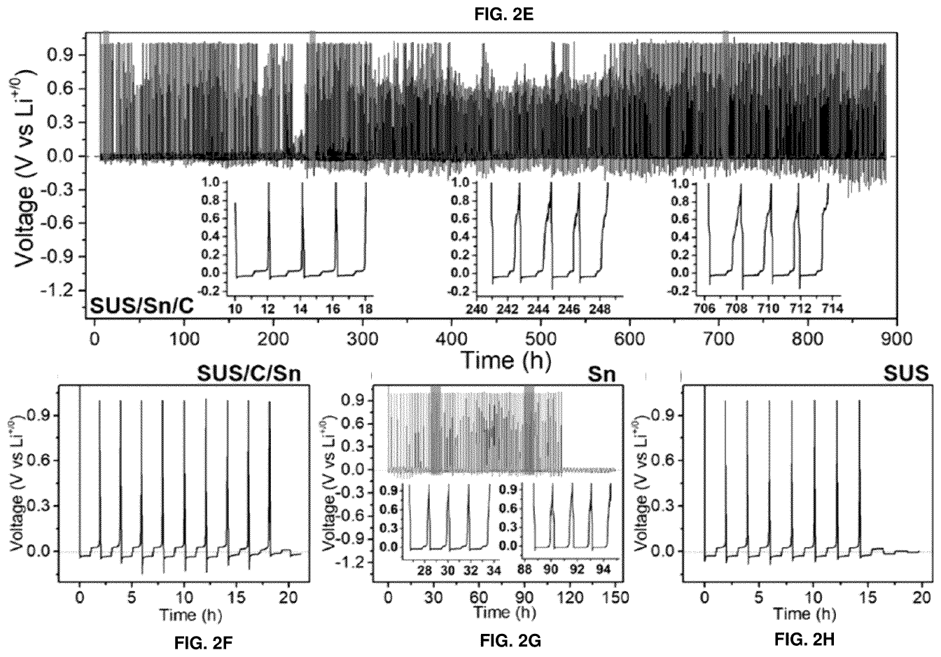

FIGS. 2A-2D show the first Li-plating (discharging)/stripping (charging) profiles of SUS/Sn/C and SUS/C/Sn BLs, compared to bare SUS foil without BLs and Sn only BL. The inset figures highlight the initial nucleation overpotential during Li plating (discharging). A voltage dip appeared at the initial stage of Li plating followed by a voltage plateau for the bare SUS foil. The gap between the voltage dip and plateau is defined as the overpotential for Li nucleation. A large overpotential, in general, indicates sluggish Li-metal nucleation and inhomogeneous Li-metal plating. To ensure the repeatability of the cell testing results for overpotentials and Coulombic efficiencies, 3 different individual cells for each sample were tested in this study. While a representative result of each sample is shown in FIGS. 2A-2D, the values described here are the average values with error bars. The cell with the bare SUS foil exhibits a large overpotential of ~30±0.924 mV, indicating slow Li-metal nucleation. The SUS/Sn/C BL, SUS/C/Sn BL, and Sn only BL show overpotentials of 12±0.924, 15±0.924, and 8.33±1.067 mV, respectively, which are much smaller than the bare SUS foil. In addition, the first-cycle Coulombic efficiencies were calculated from the voltage curves of SUS/Sn/C and SUS/C/Sn BL sputtered SUS foils, the bare SUS foil, and Sn only BL. The SUS/Sn/C BL and SUS/C/Sn BL exhibited a Coulombic efficiency of 87.6667±0.533 and 86.3333±0.533%, respectively, which are higher than the bare SUS foil (83.6667±1.411%) but lower than Sn only BL (89.6667±0.533%).

FIGS. 2E-2H show the cycling performance of the SUS/Sn/C, SUS/C/Sn, Sn only BLs, and the bare SUS foil without BL, respectively. The bare SUS foil without BL was completely short-circuited in the eighth cycle as shown in FIG. 2H. In sharp contrast, the SUS/Sn/C BL exhibited stable Li plating-stripping cycling performance without any short-circuit for 450 cycles (885 h) while the overall overpotential gradually increased during Li-plating (discharging), as shown in FIG. 2E. The insets of FIG. 2E show Li metal plating/stripping profiles at different cycling number ranges. At initial cycles, the nucleation overpotential of Li metal plating is negligible and the Li metal stripping profile shows a low voltage plateau. However, in the extended cycles, higher Li metal nucleation overpotential is observed.

In addition, the stripping voltage profiles exhibit two distinct regions: (i) a low voltage plateau, followed by (ii) a sloped voltage curve at higher potential. The sloped voltage profile with a larger overpotential region (ii) is attributable to the contact loss between the solid electrolyte and Li metal-plated anode due to the void formation. Interestingly, we found that the Li metal stripping voltage does not always reach the cutoff voltage limit (1.0 V). We suspect that the fluctuations in the voltage profiles observed at the stripping side are due to the change in interfacial contact between Li metal-plated electrode and electrolyte caused during continuous plating and stripping cycles. During repeated Li metal plating and stripping cycles, isolated dead Li metals can form because of the void formation. When the isolated dead Li metals are reconnected by Li metal plating in a subsequent cycle, the dead Li metal can be stripped out. In this case, the stripping voltage profile does not reach the voltage cutoff but is limited by the stripping capacity. With the SUS/C/Sn BL, a short-short was observed in the 10th cycle, indicated by a sudden voltage drop to near-zero voltage (FIG. 2F). For comparison, we evaluated the cycling stability of the Sn sputtered SUS foil without carbon. FIG. 2G shows the Li-plating (discharging)/stripping (charging) cycling behavior of the Sn-deposited electrode. A short-circuit was observed in the 68th cycle when Sn only BL was used. These results demonstrate that the presence and position of the carbon layer play an important role in stabilizing Li-plating (discharging)/stripping (charging) cycles and suppressing Li-dendrite growth, which will be discussed below.

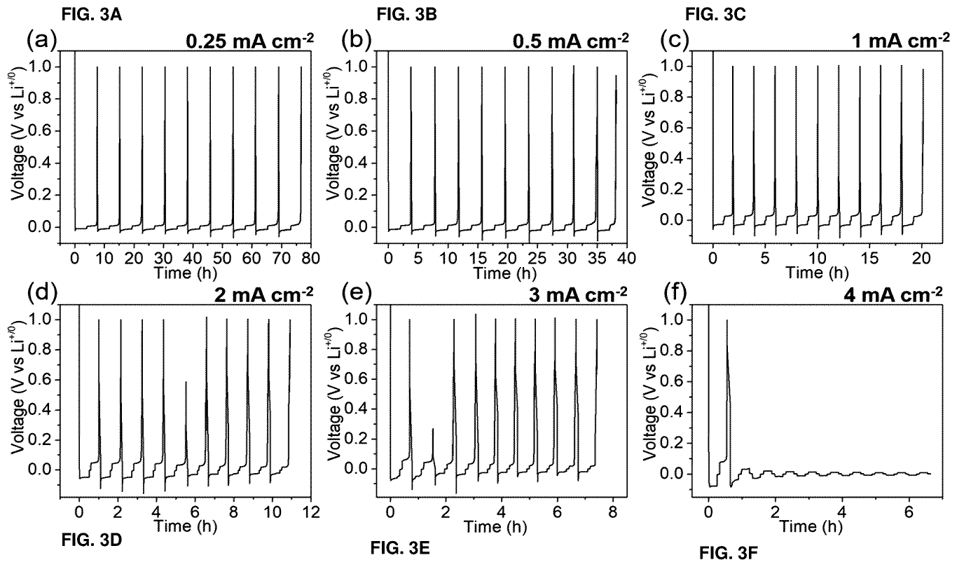

As the SUS/Sn/C BL shows stable cycling performance, we further evaluated the critical current density (CCD) of the SUS/Sn/C BL. FIGS. 3A-3F show Li-plating (discharging)/stripping (charging) cycles at varied current densities from 0.25 to 4 mA cm⁻² with a constant areal capacity of 1 mAh cm⁻² for 10 cycles with a 5 min rest after each discharge and charge step. At current densities <2 mA cm⁻², no noticeable short-circuit was observed for 10 cycles. At 3 mA cm⁻², the voltage slightly decreases in the second cycle as shown in FIG. 3E. However, the decreased voltage does not reach 0 V in sharp contrast to FIG. 3F (4 mA cm⁻²) which was completely shorted. We expect the voltage drop in the second cycle at 3 mA cm⁻² may originate from (i) a soft-short or (ii) an improved contact between Li metal-plated BL and solid electrolyte. Because Li metal plating/stripping cycle does not stop after the second cycle at 3 mA cm⁻², we do not conclude the voltage drop is the complete short-circuit. In contrast, the cell was completely short-circuited after 2 cycles when a high current density of 4 mA cm⁻² was applied.

### EXAMPLE

### Li-Metal Plating Behaviors With SUS/Sn/C and SUS/C/Sn BLs

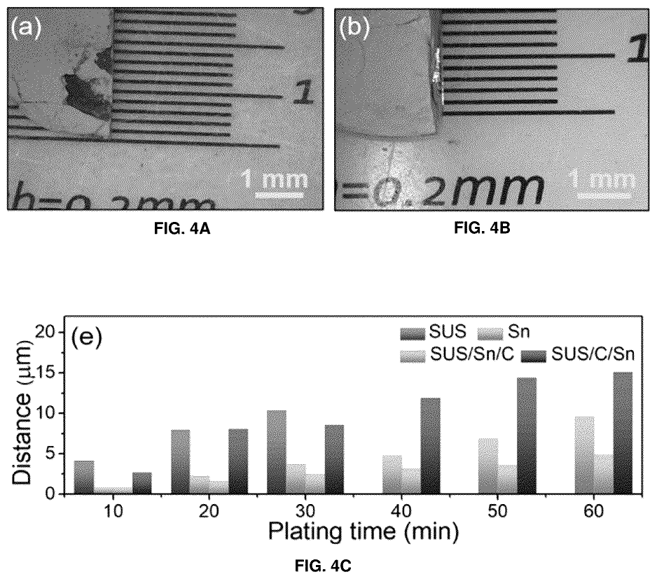

To better understand the role of the position of the carbon layer in the BL in determining the Li-plating behavior, we employed ex situ digital optical microscopy and in situ cross-sectional optical microscopy. FIGS. 4A and 4B show the ex situ optical microscopy images (top-view) of the SUS/Sn/C and SUS/C/Sn BLs after Li plating at 1 mA cm⁻² for 15 h (areal capacity: 15 mAh cm⁻²). Notably, these cells were not short-circuited during Li plating for 15 h. The cells were disassembled and the Li metal counter electrode was carefully removed from the pellet using a blade inside Ar-filled glovebox. Subsequently, the pellets, consisting of solid electrolyte |Li-plated BL| SUS foil, were cut in half using a blade inside Ar-filled glovebox. The top layer of the solid electrolyte was carefully removed to observe the interface between the solid electrolyte and BL using a digital optical microscope. All the sample preparation steps and optical microscopy measurements were conducted inside an Ar-filled glovebox to avoid any potential contamination from air exposure.

As shown in FIG. 4A, the carbon layer with black color was observed between the solid electrolyte and plated Li metal for the case of SUS/Sn/C BL. We could not observe any shiny Li metals at the interface between the solid electrolyte and BL. SEM/EDS analysis also confirmed that the black films observed in FIG. 4A are the carbon layer. Importantly, we could not observe any noticeable oxygen signal from the area where we conducted EDS mapping. The absence of an oxygen signal indicates that the material underneath the LPSCl solid electrolyte is the carbon layer, instead of other potential decomposition products such as lithium carbonate. When we scratched the carbon layer, Li metal (a shiny metallic piece) was observed, demonstrating that Li metal was plated between the carbon BL and SUS foil.

In contrast, Li metal was observed when the solid electrolyte layer was removed for the SUS/C/Sn BL, as shown in FIG. 4B. This observation likely demonstrates that the Li metal was plated between the solid electrolyte and BL. We expect the Li-metal plating beneath the carbon layer to suppress the detrimental decomposition of the solid electrolyte by avoiding direct contact between the Li metal and solid electrolyte in the SUS/Sn/C deposited BL. In addition, the presence of the carbon layer on top of the plated Li metal could act as a physical barrier to suppress Li dendrite growth and penetration into the solid electrolyte, which will be discussed further below.

We employed in situ cross-sectional optical microscopy analysis to understand how the BL configurations (SUS/Sn/C vs SUS/C/Sn) affect the uniformity of Li metal plating on the SUS foil current collector using a customized in situ solid-state battery cell design. When a fixed current rate is applied, how rapidly the gap between the solid electrolyte and SUS foil opens is inversely proportional to the homogeneity of Li metal plating. When Li metal plating is homogeneous on the SUS foil, the gap opening should be gradual and slow. In contrast, the uneven Li metal plating will open the gap between the solid electrolyte and SUS foil more significantly. in situ cross-sectional optical microscopy was performed on the area between the solid electrolyte and SUS foil with SUS/Sn/C and SUS/C/Sn BLs, respectively, as a function of Li-plating (discharging) time at 0.3 mA cm⁻². The capacity resulting from the Li—Sn alloying reaction is 0.053 mAh cm⁻² based on the mass of Sn on the BL, which is only ~17% of the total capacity. Therefore, the majority of the capacity obtained from the in situ cross-sectional optical microscopy analysis has to be related to Li plating. Voltage profiles of the in situ cross-sectional optical microscopy experiments were measured. The higher overpotential observed in these in situ experiments is attributable to the higher cell resistances in the specific setup of the in situ solid-state battery cells with a relatively low stacking pressure (<1 MPa). Before cycling, the gap between the SUS foil and the solid electrolyte for the SUS/Sn/C BL is smaller than that for the SUS/C/Sn BL, which indicates that the contact between the SUS/Sn/C BL deposited SUS foil and the solid electrolyte is better than that between the SUS/C/Sn BL deposited SUS foil and the solid electrolyte. During the Li plating (discharging), the gap between the SUS/Sn/C BL deposited SUS foil and the solid electrolyte gradually increases. In contrast, for the SUS/C/Sn BL deposited SUS foil, the gap opening between the SUS foil and solid electrolyte is much greater and faster than the SUS/Sn/C BL case during Li plating (discharging).

For comparisons, Sn only BL and bare SUS foil without BL were also tested with in situ cross-sectional optical microscopy measurements. In the case of Sn only BL, a gradual gap opening between the solid electrolyte and Sn deposited SUS foil was found, similar to the SUS/Sn/C BL system. However, the bare SUS foil exhibited a rapid gap opening between the solid electrolyte and SUS foil. In addition, a crack in the solid electrolyte started evolving after 20 min of Li metal plating and the cell was short-circuited after 30 min of Li metal plating.

FIG. 4C summarizes the gap opening between the solid electrolyte and SUS foil as a function of Li plating time with different BLs. The SUS/Sn/C BL shows the slowest and gradual gap opening between the solid electrolyte and SUS foil. In contrast, SUS/C/Sn BL exhibits a much faster gap opening than the SUS/Sn/C BL. Interestingly, Sn only BL shows a slower gap opening than the SUS/C/Sn BL. This behavior could be attributable to poor adhesion between the sputtered carbon and SUS foil. The SUS/C/Sn BL was easily detached from the SUS foil. The poor contact between BL and SUS foil can induce uneven Li plating. As expected, the bare SUS foil exhibits the fastest gap opening. Because the bare SUS foil was short-circuited after 30 min of discharging, the gap opening distance for the bare SUS foil was not plotted after 30 min in FIG. 4C. The speed of the gap opening shows the trend of the bare SUS (fastest)>SUS/C/Sn>Sn only>SUS/Sn/C (slowest). Intriguingly, this trend is inversely proportional to the cycling performance. The slower the gap opening is, the longer it cycles without short-circuiting (FIGS. 2A-2D). As we discussed above, a rapid gap opening between SUS foil and solid electrolyte indicates inhomogeneous Li metal plating. Therefore, we attribute the stable cycling performance of the SUS/Sn/C BL to their ability to homogenize Li metal plating.

### EXAMPLE

### Li-Metal Plating and Stripping Mechanisms With the SUS/Sn/C BL

To understand Li-metal plating and stripping behaviors with the SUS/Sn/C BL, we used cryo-focused ion beam (cryo-FIB) and SEM/EDS analysis after Li-metal plating and stripping at 1 mA cm⁻². We used cryo-FIB for the sample preparation to prevent Li-metal melting and potential decomposition of interphase materials due to the local heating during the FIB process. Because sulfide solid-electrolyte and interphase materials are air-and moisture-sensitive, an air-free sample preparation and transfer system was implemented to protect the samples from contamination.

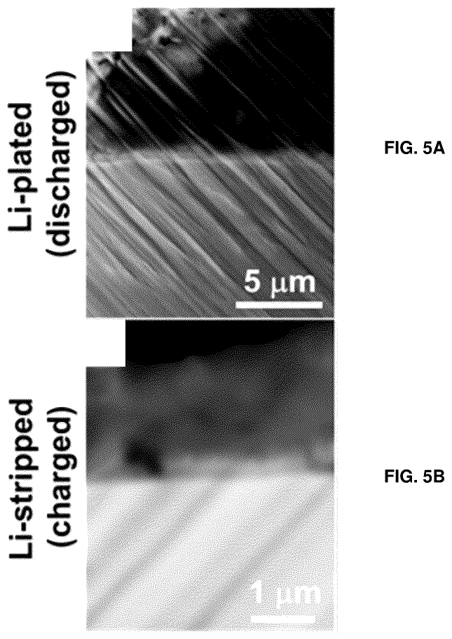

FIG. 5A shows the SEM image of the SUS/Sn/C BL deposited SUS foil after Li-metal plating at 1 mA cm⁻² with an areal capacity of 2 mAh cm⁻². After Li-metal plating, a dark area appeared in FIG. 5A with no S signal (representing Li₆PS₅Cl solid electrolyte) and no Sn signal in the EDS mapping between the solid electrolyte and SUS foil. We expect that this dark area corresponds to Li metal plated after discharging. Interestingly, the Sn signal shows a gradient from the SUS foil (high intensity) to the Li₆PS₅Cl solid electrolyte (low intensity). This gradient demonstrates that most of the Sn metal remained on the SUS foil after Li metal plating. The phase separation of Li metal and Sn-rich phase is attributable to the fact that the solid-solution alloy reaction between Li metal and Sn metal is limited to Li₂₂Sn₅ in contrast to Ag or Au that can form a wide range of solid-solution up to very high Li concentrations. The formation of Li metal and the phase separation of Li and Sn were also evidenced by ex situ XRD analysis, confirming the coexistence of Li metal and Li-Sn alloy (Li₂₂Sn₅). While a relatively concentrated carbon signal was detected on the surface of the SUS foil, it is difficult to conclude where the carbon layer presents because (i) the carbon signal is weak and (ii) the weak carbon signal is also found at the interface between the Li metal plated and the solid electrolyte. This makes it difficult to confirm whether the carbon layer is present on the top of the Li metal. However, the optical microscopy image in FIG. 4A clearly demonstrates the presence of the carbon layer on top of the Li metal.

FIG. 5B shows a SEM image of the interface between the SUS/Sn/C deposited BL and Li₆PS₅Cl solid electrolyte after Li stripping at 1 mA cm⁻² up to 1.0 V (vs Li/Li⁺). The thickness of the SUS/Sn/C BL shortened significantly to ~700 nm after Li stripping. This result indicates that the plated Li metal was removed from the anode during the charging process. The ex situ XRD analysis also confirmed the disappearance of Li metal and Li₂₂Sn₅ phases and the recovery of Sn-metal peaks after charging. Notably, the Sn and carbon layer remained at the interface between the solid electrolyte and SUS foil current collector. Although the carbon signal is weak and it is difficult to confirm the thickness, the summed line scan of the carbon signal clearly demonstrates the presence of a thin carbon layer between the solid electrolyte and SUS foil. In addition, Sn and C coexist in the same position. It is likely that the Sn and C were mixed after a Li-plating (discharging)/stripping (charging) cycle.

### EXAMPLE

Our study demonstrates that the dual SUS/Sn/C BL results in improved Li-plating (discharging)/stripping (charging) cycling without noticeable short-circuit compared to Sn only and the dual SUS/C/Sn BLs (FIGS. 2A-2H). This improvement can be explained by the presence of the protective carbon layer on top of the Li metal, as shown in FIG. 4A. The carbon layer may (i) prevent direct contact between the sulfide solid electrolyte and Li metal and (ii) serve as a physical barrier for Li-dendrite penetration. To better understand how the carbon layer prevents dendritic Li metal growth toward the solid electrolyte, we evaluated the lithiophobicity of sputtered carbon and Sn on SUS foils.

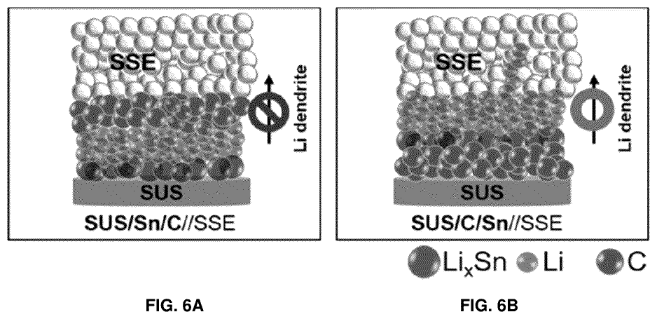

A small piece of Li metal (~1 mg) was placed on the carbon or Sn sputtered SUS foils and the bare SUS foil without BL, followed by heat treatment on a hot plate (temperature setup: 250° C.) inside Ar-filled glovebox. Digital photo images of melted Li metal on SUS foil without BL, carbon BL, and Sn BL sputtered SUS foils were recorded. Similar to the bare SUS foil without BL, melted Li metal did not show a good wettability on carbon sputtered SUS foil, indicating its lithiophobic nature. In contrast, Li metal was well spread on the Sn sputtered SUS foil, demonstrating its lithiophilic property. We expect that Li metal prefers to grow toward the SUS foil side where lithiophilic Sn metal is deposited rather than the solid electrolyte side where the lithiophobic carbon layer presents in the SUS/Sn/C BL system (FIG. 6A). Contrarily, the carbon layer on the SUS foil will function as a current collector and does not prevent Li dendrite growth toward the solid electrolyte in the SUS/C/Sn BL system (FIG. 6B). This finding highlights the importance of the lithiophobic carbon layer in BL development in suppressing Li dendrite growth and penetration toward the solid electrolyte. In particular, the lithiophobic carbon layer at the solid electrolyte side is pivotal in preventing Li dendrite growth.

### CONCLUSION

Further details regarding the embodiments described herein can be found in Venkata Sai Avvaru et al., “Tin-Carbon Dual Buffer Layer to Suppress Lithium Dendrite Growth in All-Solid-State Batteries,” ACS Nano 2025, 19, 18, 17347-17356, which is hereby incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A structure comprising:
a current collector;
a layer of metal disposed on the current collector; and
a layer of carbon disposed on the layer of metal.

2. The structure of claim 1, wherein the structure further comprises:
a solid-electrolyte layer disposed on the layer of carbon.

3. The structure of claim 1, wherein the current collector comprises a layer of stainless steel or a layer of copper.

4. The structure of claim 1, wherein a metal of the layer of metal is tin.

5. The structure of claim 1, wherein the layer of metal comprises tin.

6. The structure of claim 1, wherein the layer of metal is about 50 nanometers to 2 microns thick.

7. The structure of claim 1, wherein the layer of carbon is about 50 nanometers to 1 micron thick.

8. The structure of claim 1, wherein the structure is part of an all-solid-state battery.

9. A method comprising:
providing a current collector;
depositing a layer of metal on the current collector; and
depositing a layer of carbon on the layer of metal.

10. The method of claim 1, wherein the current collector comprises a layer of stainless steel or a layer of copper.

11. The method of claim 1, wherein the layer of metal is deposited using a sputtering method.

12. The method of claim 1, wherein a metal of the layer of metal is tin.

13. The method of claim 1, wherein the layer of metal comprises tin.

14. The method of claim 1, wherein the layer of metal is about 50 nanometers to 2 microns thick.

15. The method of claim 1, wherein the layer of carbon is deposited using a sputtering method.

16. The method of claim 1, wherein the layer of carbon is about 50 nanometers to 1 micron thick.

17. A method comprising:
providing a solid electrolyte;
depositing a layer of carbon on the solid electrolyte; and
depositing a layer of metal on the layer of carbon.

18. The method of claim 17, wherein a metal of the layer of metal is tin.

19. The method of claim 17, wherein the layer of metal is deposited using a sputtering method.

20. The method of claim 17, wherein the layer of carbon is deposited using a sputtering method.
